(19) United States
(12) Patent Application Publication
(10) Pub. No.: US 2025/0388114 A1
(43) Pub. Date: Dec. 25, 2025

(54) OPTIMIZING BATTERY CHARGING THROUGH MODEL PREDICTIVE CONTROL IN FUEL CELL ELECTRIC VEHICLES

(71) Applicant: FCA US LLC, Auburn Hills, MI (US)

(72) Inventors: Zhentao Xie, Auburn Hills, MI (US); Rudolf Kharpuri, Auburn Hills, MI (US)

(21) Appl. No.: 18/751,661

(22) Filed: Jun. 24, 2024

(51) Int. Cl. B60L 53/64; B60L 50/75; B60L 53/62; H01M 10/44; H01M 16/00; H02J 3/38

(52) U.S. Cl. CPC B60L 53/64; B60L 50/75; B60L 53/62; H01M 10/44; H01M 16/006; H02J 3/38; H01M 2220/20; H01M 2250/20; H01M 2250/402; H02J 2203/20; H02J 2310/48

(57) ABSTRACT

A charging control system for a fuel cell electric vehicle (FCEV) includes a set of sensors configured to monitor (i) an output voltage of a high voltage battery system of the FCEV and (ii) a set of constraints on an output power of a fuel cell system of the FCEV, wherein the fuel cell system is configured to charge the high voltage battery system, and a control system configured to perform model predictive control (MPC) of a power command for the fuel cell system based on a modeling of the output voltage of the high voltage battery system over a future time horizon and subject to the set of constraints on an output power of the fuel cell system, wherein the set of constraints includes a response time delay for the output power of the fuel cell system to achieve the power command.

### FIELD

The present application generally relates to fuel cell electric vehicles (FCEVs) and, more particularly, to optimizing battery charging through model predictive control in FCEVs.

### BACKGROUND

A fuel cell electric vehicle (FCEV) includes a fuel cell system (e.g., a hydrogen fuel cell system) that is configured to perform a chemical reaction to generate electrical energy. This electrical energy can then be used, for example, to recharge a high voltage battery system of the FCEV, which is used to power one or more electric traction motors for vehicle propulsion. The actual output power of the fuel cell system cannot always meet a power command. This is due to saturation of the fuel cell system caused by various power and temperature limits. Feedback controllers have been proposed to regulate the power output of the fuel cell system, but managing their response delays is very challenging, leading to sluggish performance and imprecise control. Overshooting in the power output could also occur, which could potentially result in an overvoltage condition and potential damage/degradation to the battery system (see plot 10 of FIG. 1). Accordingly, while such conventional FCEV control systems do work for their intended purpose, there exists an opportunity for improvement in the relevant art.

### SUMMARY

According to one example aspect of the invention, a charging control system for a fuel cell electric vehicle (FCEV) is presented. In one exemplary implementation, the charging control system comprises a set of sensors configured to monitor (i) an output voltage of a high voltage battery system of the FCEV and (ii) a set of constraints on an output power of a fuel cell system of the FCEV, wherein the fuel cell system is configured to charge the high voltage battery system and a control system configured to perform model predictive control (MPC) of a power command for the fuel cell system based on a modeling of the output voltage of the high voltage battery system over a future time horizon and subject to the set of constraints on an output power of the fuel cell system, wherein the set of constraints includes a response time delay for the output power of the fuel cell system to achieve the power command.

In some implementations, the control system is further configured to calculate a delta voltage between a current and a previous output voltage of the high voltage battery system, update a state matrix for the high voltage battery system with the current output voltage and the calculated delta voltage, and calculate a sequence of increments to the power command for the fuel cell system within the future time horizon accounting for its response time delay. In some implementations, the control system is further configured to abstract a first sample of the calculated sequence of power command increments and calculate the power command for the fuel cell system based on the abstracted first sample.

In some implementations, the control system is further configured to determine whether the calculated power command for the fuel cell system satisfies the set of constraints for the fuel cell system. In some implementations, when the calculated power command does not satisfy the set of constraints for the fuel cell system, the control system is further configured to modify the calculated power command by accounting for the set of constraints in minimizing a cost function to obtain a modified power command that is output to and utilized by the fuel cell system. In some implementations, the control system is configured to minimize the cost function accounting for the set of constraints using the Hildreth's Quadratic Programming Procedure.

In some implementations, a previous power command in the sequence of power command increments is updated with the calculated power command or modified power command and then saved in memory. In some implementations, the control system is further configured to receive a set of optimized parameters for the MPC control from an offline/external calibration system that executes an optimization process to predetermine the set of optimized parameters for the MPC control. In some implementations, the fuel cell system is a hydrogen fuel cell system comprising a hydrogen fuel cell stack and a fuel cell processor (FPC) configured to control an output power of the hydrogen fuel cell stack based on the power command.

According to another example aspect of the invention, a charging control method for an FCEV is presented. In one exemplary implementation, the charging control system comprises monitoring, by a control system of the FCEV and using a set of sensors, (i) an output voltage of a high voltage battery system of the FCEV and (ii) a set of constraints on an output power of a fuel cell system of the FCEV, wherein the fuel cell system is configured to charge the high voltage battery system, and performing, by the control system, model predictive control (MPC) of a power command for the fuel cell system based on a modeling of the output voltage of the high voltage battery system over a future time horizon and subject to the set of constraints on an output power of the fuel cell system, wherein the set of constraints includes a response time delay for the output power of the fuel cell system to achieve the power command.

In some implementations, the charging control method further comprises calculating, by the control system, a delta voltage between a current and a previous output voltage of the high voltage battery system, updating, by the control system, a state matrix for the high voltage battery system with the current output voltage and the calculated delta voltage, and calculating, by the control system, a sequence of increments to the power command for the fuel cell system within the future time horizon accounting for its response time delay. In some implementations, the charging control method further comprises abstracting, by the control system, a first sample of the calculated sequence of power command increments and calculating, by the control system, the power command for the fuel cell system based on the abstracted first sample.

In some implementations, the charging control method further comprises determining, by the control system, whether the calculated power command for the fuel cell system satisfies the set of constraints for the fuel cell system. In some implementations, the charging control method further comprises when the calculated power command does not satisfy the set of constraints for the fuel cell system, modifying, by the control system, the calculated power command by accounting for the set of constraints in minimizing a cost function to obtain a modified power command that is output to and utilized by the fuel cell system. In some implementations, the minimizing of the cost function accounting for the set of constraints is performed using the Hildreth's Quadratic Programming Procedure.

In some implementations, a previous power command in the sequence of power command increments is updated with the calculated power command or modified power command and then saved in memory. In some implementations, the charging control method further comprises receiving, by the control system, a set of optimized parameters for the MPC control from an offline/external calibration system that executes an optimization process to predetermine the set of optimized parameters for the MPC control. In some implementations, the fuel cell system is a hydrogen fuel cell system comprising a hydrogen fuel cell stack and an FPC configured to control an output power of the hydrogen fuel cell stack based on the power command.

Further areas of applicability of the teachings of the present application will become apparent from the detailed description, claims and the drawings provided hereinafter, wherein like reference numerals refer to like features throughout the several views of the drawings. It should be understood that the detailed description, including disclosed embodiments and drawings referenced therein, are merely exemplary in nature intended for purposes of illustration only and are not intended to limit the scope of the present disclosure, its application or uses. Thus, variations that do not depart from the gist of the present application are intended to be within the scope of the present application.

### BRIEF DESCRIPTION OF THE DRAWINGS

FIG. 1 is a plot illustrating an example overvoltage malfunction in a fuel cell electric vehicle (FCEV) according to the prior art;

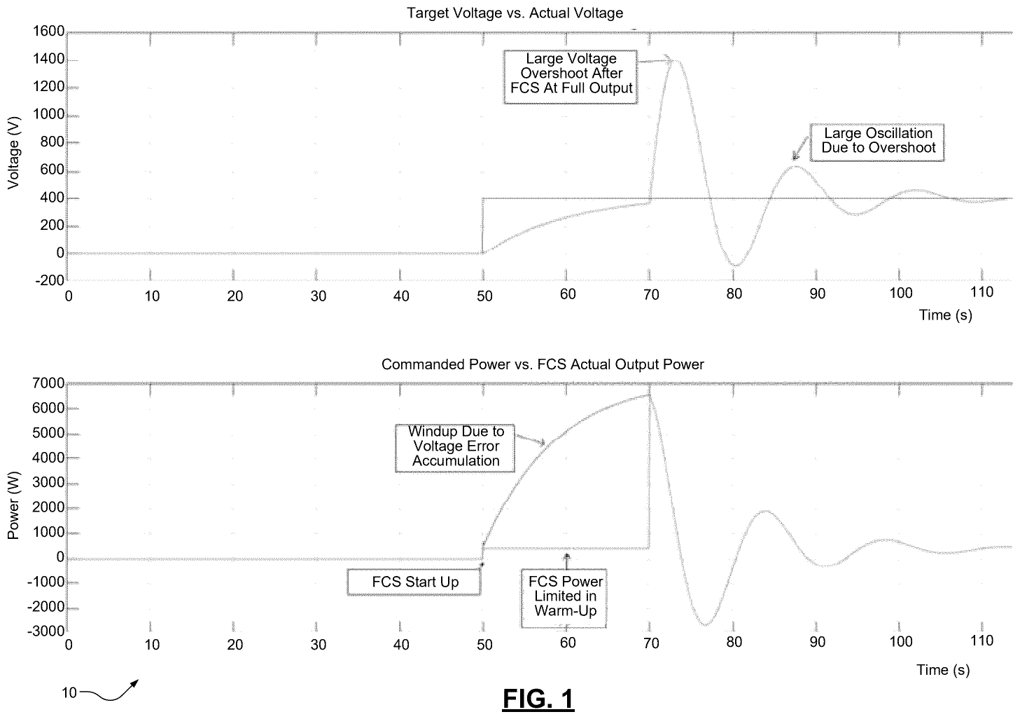

FIG. 2 is a diagram of a FCEV having an example charging control system according to the principles of the present application;

FIG. 3 is a diagram of an example architecture for the charging control system according to the principles of the present application;

FIG. 4 is a plot of example fuel cell system power commands and actual power output according to the principles of the present application; and

FIG. 5 is a flow diagram of an example charging control method for an FCEV according to the principles of the present application.

### DESCRIPTION

As previously discussed, the actual output power of a fuel cell system (e.g., a hydrogen fuel cell system) of a fuel cell electric vehicle (FCEV) cannot always meet a power command. This is due to saturation of the fuel cell system caused by warm-up power limits, temperature limits, direct current to direct current (DC-DC) converter power limits, battery charge power limits, and the like. In one exemplary implementation, the FCEV includes a supervisory controller (e.g., an electrified vehicle control unit, or EVCU), with a motor control processor (MCP) controlling the electric motor(s) and related devices (e.g., an inverter) and a fuel cell processor (FCP) controlling the fuel cell system. Feedback controllers (e.g., a proportional-integral-derivative, or PID controller) have been proposed to regulate the power output of the fuel cell system, but managing their response delays is very challenging, leading to sluggish performance and imprecise control (e.g., because PID controllers are not explicitly designed to handle constraints). Overshooting in the power output could also occur, which could potentially cause in an overvoltage condition of the battery system. This could lead to potential damage or degradation of the battery system and increased costs.

Accordingly, improved systems and methods for controlling the power output of the fuel cell system via model predictive control (MPC). A series of future voltages over a certain time horizon (e.g., 10 time steps) are predicted using a battery model and measured parameters. By considering future states and constraints, the MPC optimizes the control actions and proactively compensates for delays. The determination of the optimal parameters for the MPC, which is based on or derived from substantial linear algebra based formulations, can be performed offline during a vehicle development/calibration period and then uploaded to the vehicle for real-time usage. Potential benefits of these techniques include decreased warranty/replacement costs by more accurately/precisely controlling charging of the battery system via the fuel cell system, thereby preventing overvoltage malfunctions and extending the life of the battery system.

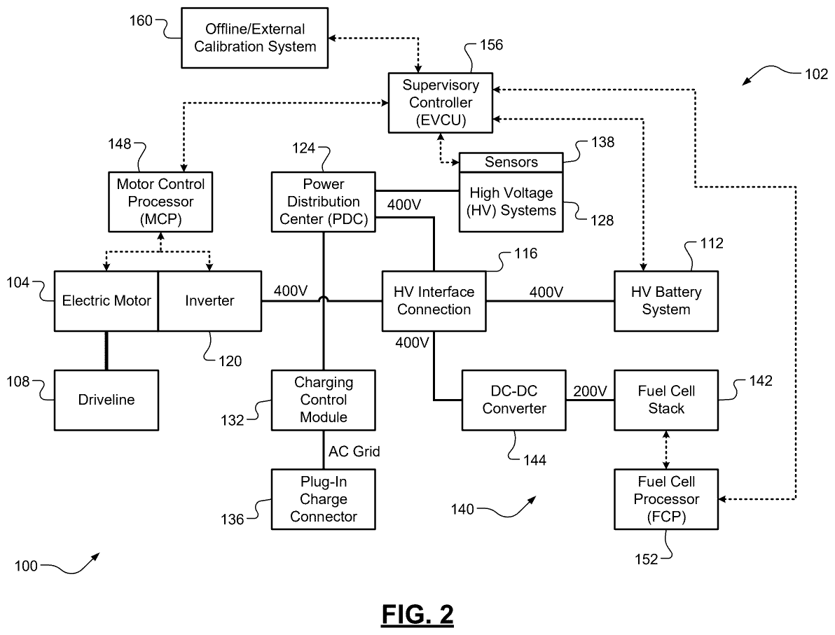

Referring now to FIG. 2, a diagram of a FCEV 100 having an example charging control system 102 according to the principles of the present application is illustrated. The FCEV 100 is controlled by a supervisory controller (EVCU) 156 and comprises one or more electric motors 104 (e.g., a three-phase electric traction motor) configured to generate drive torque that is transferred directly or via a transmission (not shown) to a driveline 108 of the FCEV 100 or to generate regenerative power by converting mechanical energy from the driveline 108. The EVCU 156 can be configured to perform the MPC of fuel cell system output power for battery system charging as discussed in greater detail herein. The electric motor 104 connected to a high voltage (HV) DC bus and to a HV battery system 112 (a HV battery pack, a battery pack control module (BPCM), HV contactors, etc.) via a HV interface connection 116 and a three-phase inverter 120, which are controlled by an MCP 148. While the HV DC bus is shown to be 400V DC, it will be appreciated that the FCEV 100 could be powered by a different HV DC power magnitude (e.g., 800V DC).

The HV DC bus is also connected to a power distribution center (PDC) 124, which is connected to other HV systems 128 (an electric air compressor, one or more electric heaters, etc.) and also to a charging control module 132 (e.g., an on-board charging or integrated dual charging module, or OBCM/IDCM). The charging control module 132 is selectively connectable to external alternating current (AC) power, such as an AC grid or charging station, via a plug-in charge connector 136. A fuel cell system 140 comprises a fuel cell stack 142 (e.g., a hydrogen fuel cell stack) configured to perform a chemical reaction to generate and output another different HV DC power and is controlled by an FCP 152. While this other different HV DC power is shown to be 200V, it will be appreciated that the fuel cell stack/system could be configured to output a lesser or greater HV DC power magnitude. A DC-DC converter 144, which could be part of or separate from the fuel cell system 140, is configured to step-up or boost the lower HV DC power output by the fuel cell stack/system (e.g., 200V DC) to the higher HV DC power at the HV interface connection 116 (e.g., 400V DC). An offline/calibration system 160 could be configured to determine and optimize parameters for the MPC techniques of the present application (e.g., during vehicle development), which could then be uploaded to the supervisory controller or EVCU 156 for subsequent usage in performing the MPC.

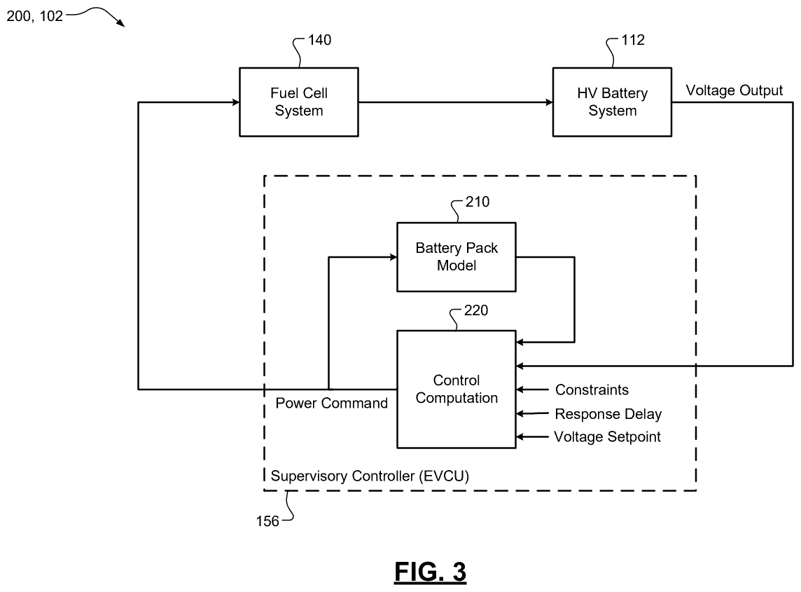

Referring now to FIG. 3 and with continued reference to FIG. 2, a diagram of an example architecture 200 of the charging control system 102 according to the principles of the present application is illustrated. FIG. 3 presents the concept of using MPC to regulate fuel cell system power for battery charging. As shown, the fuel cell system 140 is configured to charge the HV battery system 112 by selectively providing electrical energy thereto. As previously discussed, the fuel cell system 140 is configured to generate an output voltage (e.g., ˜200V DC), which could be stepped-up to a higher value (e.g., ˜400V DC) by the DC-DC converter 140. The HV battery system 112 also generates an output (“Output Voltage”), which is measured by respective sensors 138 of the electrified vehicle 100 (e.g., voltage/current sensors). While many of the operations/equations described herein are in reference to FIG. 3, it will be appreciated that the determination and optimization of the various parameters discussed below could be performed during an offline calibration process (e.g., during vehicle development) by the offline/external calibration system 160 and then uploaded to the EVCU 156 for later usage as shown in FIG. 2 and described in detail below.

The supervisory controller or EVCU 156 (hereinafter, “EVCU 156”) comprises a battery pack model 210 and a control computation block 220, which are also referenced herein as the MPC. As previously mentioned, the MPC control and its corresponding control parameters could be designed offline (e.g., during vehicle development, at the offline/external calibration system 160). The details of designing the MPC control are decomposed into three different steps: (1) system dynamic modeling, (2), predict future battery voltage over a certain time horizon and compensate response time delay, and (3) calculate control by minimizing a cost function subject to constraints on control variables. The battery pack model 210 could be, for example only, a simplified equivalent circuit model, although it will be appreciated that any suitable battery pack model could be utilized. The battery pack model 210 is configured to model and predict various parameters of the HV battery system 112 based on a power command generated by the control computation block and provided to the fuel cell system 140. As shown, the battery pack model 210 predicts voltages of the HV battery system 112 over a future time horizon (e.g., a specific number of time steps) based on the power command provided to the fuel cell system 140, which will now be discussed in greater detail.

In this system, the input is the power from the fuel cell system 140 and the output is the voltage of the HV battery system 112. There is a response delay, however, on the fuel cell power output. The fuel cell power is also constrained on rate of change and amplitude. The following is a discrete-time model for the charging control system 200:

$${x}_{m} ( k + 1 ) = {A}_{m} {x}_{m} ( k ) + {B}_{m} u ( k - d ) , \qquad ( 1 )$$

$$y ( k ) = {C}_{m} {x}_{m} ( k ) , \qquad ( 2 )$$

$$a \leq Δ u ( k ) \leq b , and \qquad ( 3 )$$

$$c \leq u ( k ) \leq d , \qquad ( 4 )$$

where xₘ(k) is the battery voltage at time step k, u(k−d) is the fuel cell charging power applied d time steps ago, which represents the response delay of fuel cell power (identifiable by experiments, model-based analysis, step response analysis, etc.), y(k) is the voltage output at time k, Aₘ, Bₘ and Cₘ are the system parameters, Δu(k) is the control rate of change, and a, b, c, d are the fuel cell system output power constraints.

Equation (1) could alternatively be derived by a battery system transfer function according to the system dynamics, and the system parameters would be variant based on different battery coefficients. Since the control rate of change Δu(k) is constrained by the system, Equations (1) and (2) are converted to the following format such that the control rate Δu(k) of change can be explicitly expressed in a state-space model.

$$x ( k + 1 ) = Ax ( k ) + B Δ u ( k - d ) , and \qquad ( 6 )$$

$$y ( k ) = Cx ( k ) , \qquad ( 7 )$$

$$where :$$

$$x ( k ) = [ \begin{matrix}Δ {x}_{m} k \\ k\end{matrix} ] ,$$

$$Δ {x}_{m} ( k ) = {x}_{m} ( k ) - {x}_{m} ( k - 1 ) ,$$

$$Δ u ( k - d ) = u ( k - d ) - u ( k - d - 1 ) ,$$

$$A = [ \begin{matrix}{A}_{m} & 0 \\ {C}_{m} {A}_{m} & 1\end{matrix} ] ,$$

$$B = [ \begin{matrix}{B}_{m} \\ {C}_{m} {B}_{m}\end{matrix} ] , and$$

$$C = [ \begin{matrix}0 & 1\end{matrix} ] .$$

As mentioned above, the MPC uses the battery model 210 to predict future voltage behavior over a certain time horizon. The length of the time horizon N is a tradeoff between control objective and computational resources. For example, a best choice or selection for the time horizon length N could be ˜8-10 time samples. By considering future battery voltages, the MPC can anticipate changes in the system. This anticipation enables the MPC to proactively adjust the fuel cell power command and compensate for the fuel cell output power response delay. The following example illustrates how to use the model to predict the future voltage and compensate for the response time delay. This example assumes the predicted horizon N equals 8 time steps and the response time step delay d equals 3. At time k, the voltage is x(k). According to Equation (6), the future predicted states are:

$$x ( k + 1 ) = Ax ( k ) + B Δ u ( k ) = A x ( k ) \qquad ( 8.1 )$$

$$x ( k + 2 ) = Ax ( k + 1 ) + B Δ u ( k + 1 ) = {A}^{2} x ( k ) \qquad ( 8.2 )$$

$$x ( k + 3 ) = Ax ( k + 2 ) + B Δ u ( k + 2 ) = {A}^{3} x ( k ) \qquad ( 8.3 )$$

$$x ( k + 4 ) = Ax ( k + 3 ) + B Δ u ( k + 3 ) = {A}^{4} x ( k ) + B Δ u ( k ) \qquad ( 8.4 )$$

$$x ( k + 5 ) = Ax ( k + 4 ) + B Δ u ( k + 4 ) = {A}^{5} x ( k ) + AB Δ u ( k ) + B Δ u ( k + 1 ) \qquad ( 8.5 )$$

$$x ( k + 6 ) = Ax ( k + 5 ) + B Δ u ( k + 5 ) = {A}^{6} x ( k ) + {A}^{2} B Δ u ( k ) + AB Δ u ( k + 1 ) + B Δ u ( k + 2 ) \qquad ( 8.6 )$$

$$x ( k + 7 ) = Ax ( k + 6 ) + B Δ u ( k + 6 ) = {A}^{7} x ( k ) + {A}^{3} B Δ u ( k ) + {A}^{2} B Δ u ( k + 1 ) + AB Δ u ( k + 2 ) + B Δ u ( k + 3 ) \qquad ( 8.7 )$$

$$x ( k + 8 ) = Ax ( k + 7 ) + B Δ u ( k + 7 ) = {A}^{8} x ( k ) + {A}^{4} B Δ u ( k ) + {A}^{3} B Δ u ( k + 1 ) + {A}^{2} B Δ u ( k + 2 ) + AB Δ u ( k + 3 ) + B Δ u ( k + 4 ) \qquad ( 8.8 )$$

$$x ( k + 9 ) = Ax ( k + 8 ) + B Δ u ( k + 8 ) = {A}^{9} x ( k ) + {A}^{5} B Δ u ( k ) + {A}^{4} B Δ u ( k + 1 ) + {A}^{3} B Δ u ( k + 2 ) + {A}^{2} B Δ u ( k + 3 ) + AB Δ u ( k + 4 ) + B Δ u ( k + 5 ) \qquad ( 8.9 )$$

$$x ( k + 10 ) = Ax ( k + 9 ) + B Δ u ( k + 9 ) = {A}^{10} x ( k ) + {A}^{6} B Δ u ( k ) + {A}^{5} B Δ u ( k + 1 ) + {A}^{4} B Δ u ( k + 2 ) + {A}^{3} B Δ u ( k + 3 ) + {A}^{2} B Δ u ( k + 4 ) + AB Δ u ( k + 5 ) + B Δ u ( k + 6 ) \qquad ( 8.1 )$$

$$x ( k + 11 ) = Ax ( k + 10 ) + B Δ u ( k + 10 ) = {A}^{11} x ( k ) + {A}^{7} B Δ u ( k ) + {A}^{6} B Δ u ( k + 1 ) + {A}^{5} B Δ u ( k + 2 ) + {A}^{4} B Δ u ( k + 3 ) + {A}^{3} B Δ u ( k + 4 ) + {A}^{2} B Δ u ( k + 5 ) + AB Δ u ( k + 6 ) + B Δ u ( k + 7 ) \qquad ( 8.11 )$$

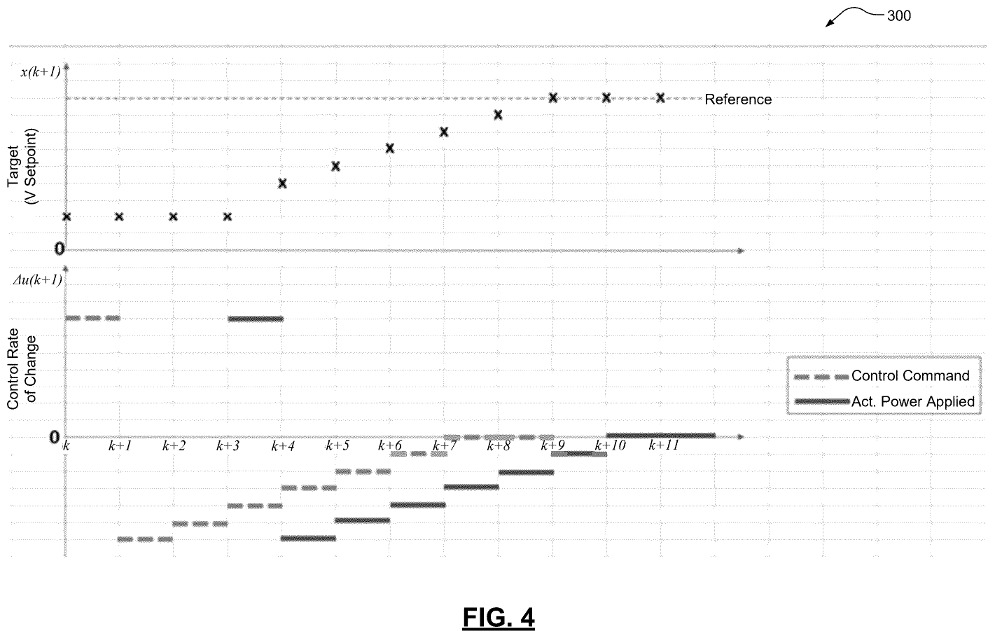

The first three steps control variable increments Δu are zeros in Equations (8.1) to (8.3) due to the response delay. Equation (8.4) shows that the first control increment Δu(k) is calculated based on the state x(k+3) to update x(k+4). This Δu(k) is calculated and requested to the fuel cell system at time step k, and due to the response delay the actual fuel cell power is applied at time step k+3. Similarly, in Equations (8.5) to (8.11), the rest of the control increment series Δu(k+1) to Δu(k+8) in the horizon are calculated based on the states x(k+4) to x(k+11). In general, this technique uses the series model predicted states x(k+i+d) to calculate the series of control increments Δu(k+i), where i=12 3 . . . . N, which can compensate the response delay. FIG. 4 illustrates a plot 300 of this example. The series-state model prediction Equations (8.1)-(8.11) can be written in a compact form as:

$$X = Dx ( k ) + δΔ U , \qquad ( 9 )$$

$$where :$$

$$D = [ \begin{matrix}{A}^{d + 1} \\ {A}^{d + 2} \\ {A}^{d + 3} \\ ⋮ \\ {A}^{d + N}\end{matrix} ] ,$$

$$δ = [ \begin{matrix}B & 0 & 0 & ⋯ & 0 \\ AB & B & 0 & ⋯ & 0 \\ {A}^{2} B & AB & B & ⋯ & 0 \\ ⋮ & ⋮ & ⋮ & ⋯ & 0 \\ {A}^{N - 1} B & {A}^{N - 2} B & {A}^{N - 3} B & ⋯ & B\end{matrix} ] , and$$

$$Δ U = [ \begin{matrix}Δ u ( k ) \\ Δ u ( k + 1 ) \\ Δ u ( k + 2 ) \\ ⋮ \\ Δ u ( k + n - 1 )\end{matrix} ] .$$

According to Equation (7)—i.e., multiplying equation (9) by matrix C—the compact format of predicted system output within the horizon is:

$$Y = Gx ( k ) + ΦΔ U , \qquad ( 10 )$$

$$where ,$$

$$G = [ \begin{matrix}{CA}^{d + 1} \\ {CA}^{d + 2} \\ {CA}^{d + 3} \\ ⋮ \\ {CA}^{d + N}\end{matrix} ] , and$$

$$Φ = [ \begin{matrix}CB & 0 & 0 & ⋯ & 0 \\ CAB & CB & 0 & ⋯ & 0 \\ {CA}^{2} B & ACB & CB & ⋯ & 0 \\ ⋮ & ⋮ & ⋮ & ⋯ & 0 \\ {CA}^{N - 1} B & {CA}^{N - 2} B & {CA}^{N - 3} B & ⋯ & CB\end{matrix} ] .$$

The goal of the MPC, for a specified setpoint r (k) at sample time step k, within a prediction horizon, is to minimize the error between the predicted output and the constant set-point signal. This aim is translated into a design task, where the objective is to determine the optimal control parameter vector that minimizes the error function between the setpoint and the predicted output. The setpoint information within the time horizon is

$${R}_{s}^{T} = [ \begin{matrix}1 & 1 & … & 1\end{matrix} ] r ( k ) .$$

A cost function J can be defined to reflect the control objective as:

$$J = {( {R}_{s} - y )}^{T} ( {R}_{s} - y ) + Δ {U}^{T} K Δ U , \qquad ( 11 )$$

where the first term is associated with the aim of minimizing discrepancies between the predicted output and setpoint, while the second term signifies the consideration given to the magnitude of AU when striving to minimize the objective function J. Variable K represents a diagonal matrix K=kI_{N×N}, where k serves as a tuning parameter for achieving the desired closed-loop performance. In the scenario where k equals 0, the cost function implies that no emphasis is placed on the magnitude of ΔU, and the primary objective is to minimize the error. Conversely, for a large k, the cost function indicates a careful consideration of the magnitude of ΔU, with a cautious effort to reduce the error.

In seeking the optimal control increment ΔU to minimize J, the expression for J, as per equation 10, is formulated as follows:

$$J = {( {R}_{s} - Gx ( k ) )}^{T} ( {R}_{s} - Gx ( k ) ) - 2 Δ {U}^{T} {Φ}^{T} ( {R}_{s} - Gx ( k ) ) + Δ {U}^{T} ( {Φ}^{T} Φ + K ) Δ U . \qquad ( 12 )$$

The prerequisite for achieving the minimum/is determined as:

$$\frac{\partial J}{\partial Δ U} = 0.$$

From this, the optimal solution for the series control increment is linked to the setpoint Rₛ and state variables x(k):

$$Δ U = {( {Φ}^{T} Φ + K )}^{- 1} {Φ}^{T} ( {R}_{s} - Gx ( k ) ) . \qquad ( 13 )$$

While the optimal parameter vector ΔU contains controls increment such as Δu(k), Δu(k+1), Δu(k+2), Δu(k+3), . . . , Δu(k+N−1), the implementation adheres to the receding horizon control principle, wherein only the first sample of this sequence ΔU(1) is executed, i.e. Δu(k)=ΔU(1), and the rest are ignored.

The control amplitude signal which is the power request to the fuel cell is:

$$u ( k ) = u ( k - 1 ) + Δ u ( k ) , \qquad ( 14 )$$

where u(k−1) is the last time step control signal which is saved in the memory. If the control amplitude u(k) or control increment Δu(k) does not satisfy the constraints expressed in Inequations (3) and (4), the control increment Δu(k) needs to be modified by accounting the constraint conditions. Therefore, a constraint condition is added into the cost function (12):

$$minJ = {( {R}_{s} - Gx ( k ) )}^{T} ( {R}_{S} - Gx ( k ) ) - 2 Δ {U}^{T} {Φ}^{T} ( {R}_{s} - Gx ( k ) ) + Δ {U}^{T} ( {Φ}^{T} Φ + K ) Δ U , \qquad ( 15 )$$

$$subject to M Δ U \leq γ . \qquad ( 16 )$$

The Inequation (4) can be rewritten as:

$$c \leq u ( k - 1 ) + Δ u ( k ) \leq d . \qquad ( 17 )$$

Then Inequations (3) and (17) can be combined in a compact matrix format:

$$[ \begin{matrix}1 \\ - 1 \\ 1 \\ - 1\end{matrix} ] Δ u ( k ) \leq [ \begin{matrix}b \\ - a \\ d - u ( k - 1 ) \\ - c + u ( k - 1 )\end{matrix} ] . \qquad ( 18 )$$

Therefore:

$$M = [ \begin{matrix}1 \\ - 1 \\ 1 \\ - 1\end{matrix} ] , γ = [ \begin{matrix}b \\ - a \\ d - u ( k - 1 ) \\ - c + u ( k - 1 )\end{matrix} ] .$$

The problem expressed by (15) and (16) can be converted to another problem:

$${min}_{λ \geq 0} ( \frac{1}{2} {λ}^{T} H λ + {λ}^{T} T + \frac{1}{2} {{λ}^{T} ( {Φ}^{T} Φ + K )}^{- 1} λ ) , \qquad ( 19 )$$

where:
λ is a vector whose dimension is same as vector M,

$$H = {M ( {Φ}^{T} Φ + K )}^{- 1} {M}^{T} + K , and$$

$$T = γ + {M ( {Φ}^{T} Φ + K )}^{- 1} {Φ}^{T} ( Gx ( k ) - {R}_{s} ) .$$

The problem (19) is to find optimal λ (λ≥0) that minimize the (19). The Hildreth's Quadratic Programming Procedure can be used to solve this problem. This involves iteratively calculating each element value of vector λ^{m+1} by using the equation:

$${λ}_{i}^{m + 1} = max ( 0 , {H}_{( i , i )}^{- 1} [ {T}_{i} + {H}_{( i , : )} {λ}^{m} - {H}_{( i , i )} {λ}_{i}^{m} ] ) , \qquad ( 20 )$$

where, i=1, 2, . . . , size (M) is the vector index number. When λ^{m}==λ^{m+1}, the iteration can be stopped and the optimal solution λ is found. The final control increment is:

$$Δ U *= {( {Φ}^{T} Φ + K )}^{- 1} [ {Φ}^{T} ( {R}_{s} - Gx ( k ) ) - {M}^{T} λ ] . \qquad ( 21 )$$

According to the receding horizon control principle, only the first sample of this sequence ΔU* is executed Δu(k)*=ΔU*(1) and control amplitude is u*(k)=u*(k−1)+Δu*(k).

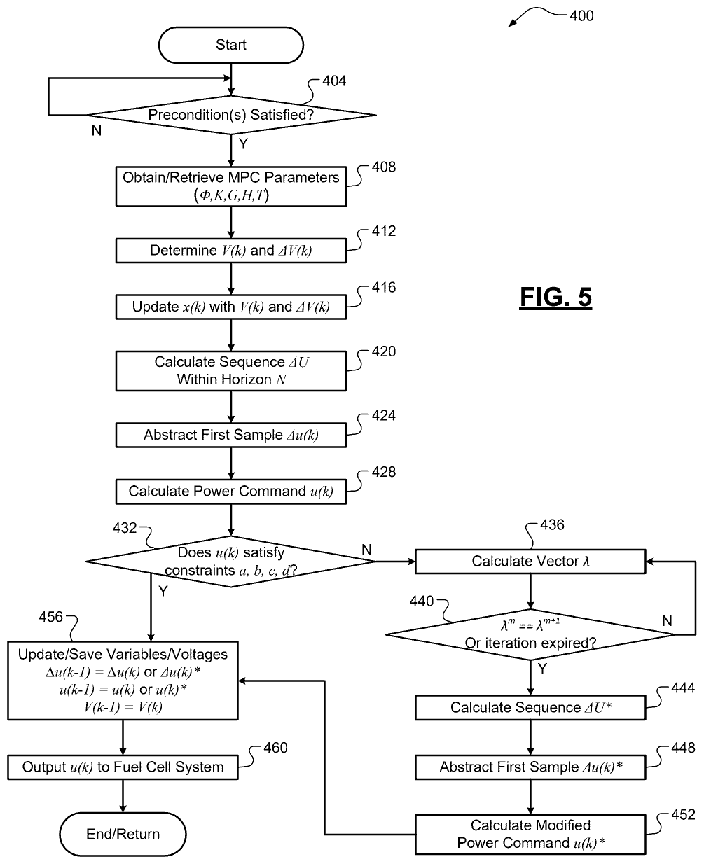

Referring now to FIG. 5 and with continued reference to FIGS. 2-3, a flow diagram of an example charging control method 400 in a FCEV according to the principles of the present application is illustrated. While the components of the FCEV 100 and the architecture 200 are specifically referenced for illustrative/descriptive purposes, it will be appreciated that the method 400 could be applicable to any suitably configured FCEV. The method 400 begins at 404 where the EVCU 156 optionally determines whether a set of one or more preconditions are satisfied. This could include, for example only, the fuel cell system 208 being powered up and there being no malfunctions or faults present that would otherwise inhibit or negatively impact the operation of the techniques of the present application. When false, the method 400 ends or returns to 404. When true, the method 400 proceeds to 408. At 408, the EVCU 156 obtains the MPC parameters (Φ, K, G, H, T) via an offline calibration/design process (e.g., from offline/external calibration system 160) using the linear algebra equations and other techniques described in detail above. For example, these MPC parameters could have already been determined by the offline/external calibration system 160 and then uploaded into a memory of the EVCU 156 and the EVCU 156 could subsequently retrieve them from the memory for subsequent MPC usage as described herein. At 412, the EVCU 156 determines the voltage of the HV battery system 112 V(k) (e.g., using a current/voltage sensor) and then calculates the battery voltage delta (ΔV=V(k) V(k+1)). At 416, the EVCU 156 updates the state matrix x(k) with the battery voltage delta ΔV and V(k).

At 420, the EVCU 156 calculates the sequence of control increments within the horizon (ΔU=(Φ^{T}Φ+K)⁻¹Φ^{T} (Rₛ−Gx(k)). At 424, the EVCU 156 abstracts the first sample of the sequence (Δu(k)=ΔU(I). At 428, the EVCU 156 calculates the power command, also described herein as a control amplitude (u(k)=u(k+1)+Δu(k). At 432, the EVCU 156 checks if the calculated control amplitude meets the constraints (a≤Δu(k)≤b; c≤u(k)≤d). When false, the method 400 proceeds to 436. When true, the method 400 proceeds to 456. At 436, the EVCU 156 calculates each element for the λ vector

$$( {λ}_{i}^{m + 1} = max ( 0 , {H}_{( i , i )}^{- 1} [ {T}_{i} + {H}_{( i , : )} {λ}^{m} - {H}_{( i , i )} {λ}_{i}^{m} ] ) ) .$$

At 440, the EVCU 156 determines whether λ^{m}==λ^{m+1} or the iteration has expired. When false, the method 400 returns to 436. When true, the method 400 proceeds to 444. At 444, the EVCU 156 calculates the sequence of control increments subject to the constraints (ΔU*=(Φ^{T}Φ+K)⁻¹[Φ^{T} (Rₛ−Gx(k))−M^{T}λ]). At 448, the EVCU 156 abstracts the first sample of the sequence (Δu(k)*=ΔU*(1)). At 452, the EVCU 156 calculates the control amplitude (u*(k)=u*(k−1)+Δu*(k). At 456, the EVCU 156 (i) updates the last step control variables with the current step variables and saves them in memory (Δu(k−1)=Δu(k); u(k−1)=u(k)) and (ii) updates the last voltage step reading with the current step voltage readings and saves it in the memory (V(k−1)=V(k)). At 460, the EVCU 156 outputs the control u(k) to the fuel cell system 140 (e.g., the FPC 152), which uses this command to adjust its output power u(k−d) for charging the HV battery system 112, subject to the output constraints d of the fuel cell system 140. The method 400 then ends or returns to 408 and continues the process until the target voltage/setpoint for the HV battery system 112 is achieved.

It will be appreciated that the terms “controller” and “control system” as used herein refer to any suitable control device or set of multiple control devices that is/are configured to perform at least a portion of the techniques of the present application. Non-limiting examples include an application-specific integrated circuit (ASIC), one or more processors and a non-transitory memory having instructions stored thereon that, when executed by the one or more processors, cause the controller to perform a set of operations corresponding to at least a portion of the techniques of the present application. The one or more processors could be either a single processor or two or more processors operating in a parallel or distributed architecture.

It should also be understood that the mixing and matching of features, elements, methodologies and/or functions between various examples may be expressly contemplated herein so that one skilled in the art would appreciate from the present teachings that features, elements and/or functions of one example may be incorporated into another example as appropriate, unless described otherwise above.

What is claimed is:

1. A charging control system for a fuel cell electric vehicle (FCEV), the charging control system comprising:
a set of sensors configured to monitor (i) an output voltage of a high voltage battery system of the FCEV and (ii) a set of constraints on an output power of a fuel cell system of the FCEV, wherein the fuel cell system is configured to charge the high voltage battery system; and
a control system configured to perform model predictive control (MPC) of a power command for the fuel cell system based on a modeling of the output voltage of the high voltage battery system over a future time horizon and subject to the set of constraints on an output power of the fuel cell system,
wherein the set of constraints includes a response time delay for the output power of the fuel cell system to achieve the power command.

2. The charging control system of claim 1, wherein the control system is further configured to:
calculate a delta voltage between a current and a previous output voltage of the high voltage battery system;
update a state matrix for the high voltage battery system with the current output voltage and the calculated delta voltage; and
calculate a sequence of increments to the power command for the fuel cell system within the future time horizon accounting for its response time delay.

3. The charging control system of claim 2, wherein the control system is further configured to abstract a first sample of the calculated sequence of power command increments and calculate the power command for the fuel cell system based on the abstracted first sample.

4. The charging control system of claim 3, wherein the control system is further configured to determine whether the calculated power command for the fuel cell system satisfies the set of constraints for the fuel cell system.

5. The charging control system of claim 4, wherein when the calculated power command does not satisfy the set of constraints for the fuel cell system, the control system is further configured to modify the calculated power command by accounting for the set of constraints in minimizing a cost function to obtain a modified power command that is output to and utilized by the fuel cell system.

6. The charging control system of claim 5, wherein the control system is configured to minimize the cost function accounting for the set of constraints using the Hildreth's Quadratic Programming Procedure.

7. The charging control system of claim 5, wherein a previous power command in the sequence of power command increments is updated with the calculated power command or modified power command and then saved in memory.

8. The charging control system of claim 1, wherein the control system is further configured to receive a set of optimized parameters for the MPC control from an offline/external calibration system that executes an optimization process to predetermine the set of optimized parameters for the MPC control.

9. The charging control system of claim 1, wherein the fuel cell system is a hydrogen fuel cell system comprising a hydrogen fuel cell stack and a fuel cell processor (FPC) configured to control an output power of the hydrogen fuel cell stack based on the power command.

10. A charging control method for a fuel cell electric vehicle (FCEV), the charging control system comprising:
monitoring, by a control system of the FCEV and using a set of sensors, (i) an output voltage of a high voltage battery system of the FCEV and (ii) a set of constraints on an output power of a fuel cell system of the FCEV, wherein the fuel cell system is configured to charge the high voltage battery system; and
performing, by the control system, model predictive control (MPC) of a power command for the fuel cell system based on a modeling of the output voltage of the high voltage battery system over a future time horizon and subject to the set of constraints on an output power of the fuel cell system,
wherein the set of constraints includes a response time delay for the output power of the fuel cell system to achieve the power command.

11. The charging control method of claim 11, further comprising:
calculating, by the control system, a delta voltage between a current and a previous output voltage of the high voltage battery system;
updating, by the control system, a state matrix for the high voltage battery system with the current output voltage and the calculated delta voltage; and
calculating, by the control system, a sequence of increments to the power command for the fuel cell system within the future time horizon accounting for its response time delay.

12. The charging control method of claim 11, further comprising abstracting, by the control system, a first sample of the calculated sequence of power command increments and calculating, by the control system, the power command for the fuel cell system based on the abstracted first sample.

13. The charging control method of claim 12, further comprising determining, by the control system, whether the calculated power command for the fuel cell system satisfies the set of constraints for the fuel cell system.

14. The charging control method of claim 13, further comprising when the calculated power command does not satisfy the set of constraints for the fuel cell system, modifying, by the control system, the calculated power command by accounting for the set of constraints in minimizing a cost function to obtain a modified power command that is output to and utilized by the fuel cell system.

15. The charging control method of claim 14, wherein the minimizing of the cost function accounting for the set of constraints is performed using the Hildreth's Quadratic Programming Procedure.

16. The charging control method of claim 14, wherein a previous power command in the sequence of power command increments is updated with the calculated power command or modified power command and then saved in memory.

17. The charging control method of claim 10, further comprising receiving, by the control system, a set of optimized parameters for the MPC control from an offline/external calibration system that executes an optimization process to predetermine the set of optimized parameters for the MPC control.

18. The charging control method of claim 10, wherein the fuel cell system is a hydrogen fuel cell system comprising a hydrogen fuel cell stack and a fuel cell processor (FPC) configured to control an output power of the hydrogen fuel cell stack based on the power command.
